(19) United States
(12) Patent Application Publication
(10) Pub. No.: US 2002/0160820 A1
(43) Pub. Date: Oct. 31, 2002

(54) Enhance mobility of a bluetooth headset beyond the reach supported by bluetooth

(76) Inventor: Thomas Winkler, Vancouver (CA)

Correspondence Address: Docket Clerk, P.O. Box 802432, Dallas, TX, 75380, US

(21) Appl. No.: 09/846,073

(22) Filed: Apr. 30, 2001

(51) Int. Cl. H04M 1/00

(52) U.S. Cl. 455/568; 455/41

(57) ABSTRACT

A communications system such as a local area data network is equipped with a plurality of access points each capable of emulating either a phone mated with a wireless headset, the wireless headset, or both and establishing a link between access points emulating the phone and the headset. When the phone is within range of an access point and the wireless headset moves out of range with the phone but within range of an access point, the access point within range of the phone emulates the headset, the access point within range of the headset emulates the phone, and a communications path is established (if necessary) between the access points. In this manner, the effective range of the headset with respect to the associated phone is extended beyond a distance limit for a wireless communications protocol, such as Bluetooth, employed for the headset and phone.

### TECHNICAL FIELD OF THE INVENTION

The present invention is directed, in general, to connectivity for wireless telephone headsets and, more specifically, to improving the mobility of wireless headsets with regard to associated phones despite distance constraints for direct wireless connection of the headset and phone.

### BACKGROUND OF THE INVENTION

The Bluetooth specification, promulgated by the Bluetooth Special Interest Group (Bluetooth SIG, Inc.) and available at www.bluetooth.com, relates to wireless connectivity of various devices, such as computers, personal digital assistants (PDAs), wireless telephones, and the like. Generally speaking, Bluetooth is a short-range radio frequency (RF) technology which enables features such as cable replacement (with wireless connections), wireless local area network (LAN) access within a short distance, and ad-hoc networks between several devices.

The Bluetooth specification includes a “core,” which specifies components such as the radio, baseband, link manager, service discovery protocol, transport layer, and interoperability with different communication protocols, and “profiles,” which specify the protocols and procedures for different types of applications.

Bluetooth normally supports distances of up to 10 meters. As a result, wireless headset users must remain within 10 meters of the phone with which the headset is associated, for example by carrying the (mobile) phone as well as the headset or by remaining within the proximity of the (stationary) phone.

For stationary phones, the problems associated with the distance limitation are self-evident. Even for mobile phones, however, the constraint on distance separating the headset and phone is problematic. For example, many users will customarily remove their phones from the belt clip while in their office or work space, place the phone on a desk or table (for example, in a charging cradle), then forget the phone when leaving their immediate work space. Movement significantly outside the user's work space will quickly separate the phone and headset by a distance larger than 10 meters, causing the user to miss incoming calls and be unable to place outgoing calls.

Alternatively, the phone—especially a media phone or a phone with an integral personal digital assistant and/or personal computer-type application capabilities (such as the Nokia 9210 Communicator)—may be in use (i.e., connected to a projector to display some data), preventing the user from carrying the phone when moving outside their workspace or a meeting location.

There is, therefore, a need in the art for extending the operational range of wireless headsets and improving the mobility of such headsets with regard to associated phones.

### SUMMARY OF THE INVENTION

To address the above-discussed deficiencies of the prior art, it is a primary object of the present invention to provide, for use in a communications system such as a local area data network, a plurality of access points each capable of emulating either a phone mated with a wireless headset, the wireless headset, or both and of establishing a link between access points emulating the phone and the headset. When the phone is within range of an access point and the wireless headset moves out of range with the phone but within range of an access point, the access point within range of the phone emulates the headset, the access point within range of the headset emulates the phone, and a communications path is established (if necessary) between the access points. In this manner, the effective range of the headset with respect to the associated phone is extended beyond a distance limit for a wireless communications protocol, such as Bluetooth, employed for the headset and phone.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise, ” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a system for extending the range of a wireless headset beyond the distance supported by an applicable wireless communications protocol according to one embodiment of the present invention;

FIG. 2 illustrates in greater detail the logical construction of a LAN access point employed for extending the range of a wireless headset beyond the distance supported by an applicable wireless communications protocol according to one embodiment of the present invention; and

FIGS. 3A-3B are a high level flow chart for a process of extending the range of a wireless headset beyond the distance supported by an applicable wireless communications protocol according to one embodiment of the present invention.

### DETAILED DESCRIPTION OF THE INVENTION

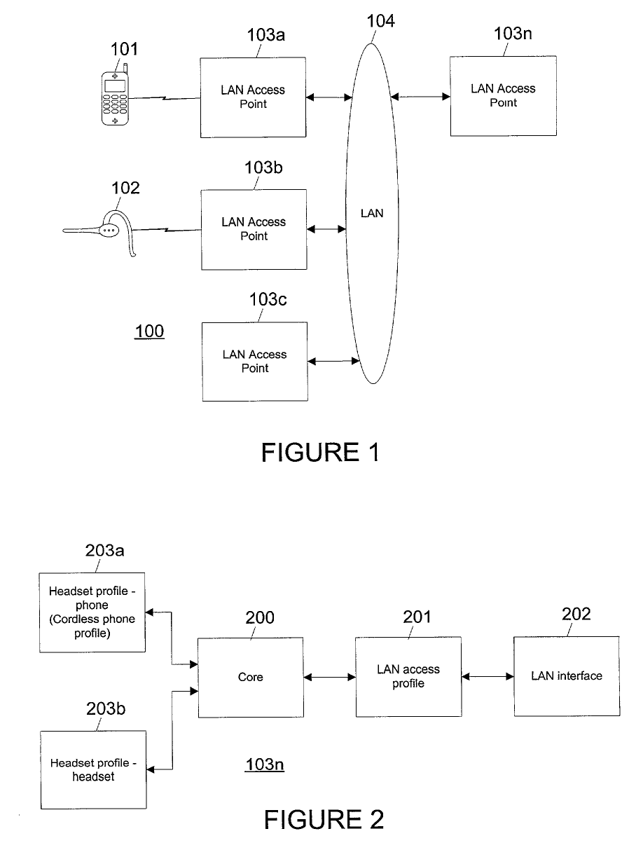

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a system for extending the range of a wireless headset beyond the distance supported by an applicable wireless communications protocol according to one embodiment of the present invention. The system 100 includes a phone 101, which is depicted as a mobile (wireless) telephone but which may alternatively be a stationary (landline) telephone. A wireless headset 102 is associated with the phone 101, allowing the user to communicate (i.e., conduct voice conversations) over the phone without utilizing the microphone and earpiece (or speaker) conventionally integrated within telephones. In the exemplary embodiment, headset 102 and phone 101 preferably communicate via the Bluetooth protocol, but may alternatively communicate via any other similar and/or suitable protocol allowing wireless communication between headset 102 and phone 101. For example, a custom wireless communications configuration may be employed for headset 102 and phone 101.

As noted above, the Bluetooth protocol is generally limited to communication over distances of ten meters or less. Alternative protocols for communications between headset 102 and phone 101 are likely to also be subjected to distance constraints. The present invention allows headset 102 to be employed in conjunction with phone 101 at distances (between headset 102 and phone 101) greater than the applicable distance (or range) limit.

In describing the invention below, reference will be made solely to the Bluetooth protocol. Those skilled in the art, however, will recognize that the principles of the present invention may be readily adapted and/or extended to any wireless communications system having the requisite capabilities for implementing the present invention.

As noted above, Bluetooth supports a number of “profiles,” protocols and procedures for different types of wireless communications applications. Among the profiles is a headset profile, a mode of operation by which a Bluetooth enabled wireless headset (e.g., headset 102) may be connected to a Bluetooth enabled telephone (e.g., phone 101) without wires, regardless of whether the phone is mobile/wireless or stationary/landline. Another profile defined by Bluetooth is a LAN access profile, a mode of operation by which any device, including a phone or computer, can access a local area network without a wired connection utilizing a Bluetooth LAN access point, and thereby access the Internet through the local area network. Still another defined profile is a cordless phone profile, in which a telephone is wirelessly coupled to a base station directly connected to a landline.

The present invention employs a number of Bluetooth-compliant LAN access points 103a-103n, where “n” represents any positive integer number of LAN access points. Each LAN access point 103a-103n is a device similar to a router or bridge, and supports Bluetooth, with the LAN access profile, on one side and provides a LAN interface (e.g., an Ethernet interface) on the other. LAN access points 103a-103n are preferably integrated into data processing systems (e.g., desktop workstations) coupled to a local area network backbone 104—that is, coupled to or installed within workstations for an enterprise local area network. In this manner, support for extending the range of a Bluetooth-compliant headset may be readily implemented without a significant amount of specialized or dedicated infrastructure; existing infrastructure employed for data communication over the local area network backbone 104 may simply be reused for wireless voice communications. In general, however, LAN access points 103a-103n may be mounted anywhere within a building or public area.

While the phone 101 and headset 102 are normally “mated” for wireless communications, in the present invention LAN access points 103a-103n emulate the phone and headset functions normally supported by the phone 101 or headset 102. One LAN access point 103a, which is physically proximate to (i.e., within the applicable range or distance limit) the phone 101, mates with the phone 101 and pretends to be the headset 102. Another LAN access point 103b, which is physically proximate to the headset 102, mates with the headset 102 and pretends to be the phone 101.

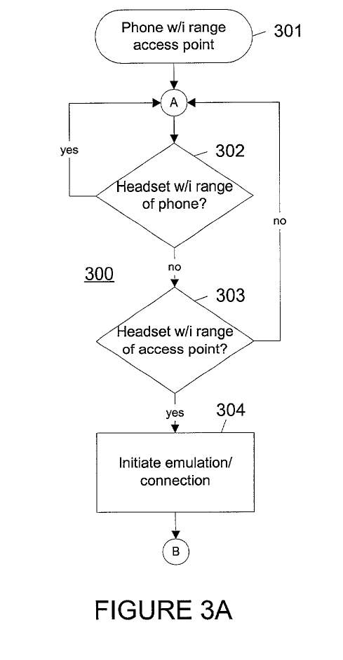

FIG. 2 illustrates in greater detail the logical construction of a LAN access point employed for extending the range of a wireless headset beyond the distance supported by an applicable wireless communications protocol according to one embodiment of the present invention. LAN access point 103n, representative of all LAN access points 103a-103n, includes a Bluetooth core 200 which provides link management, service discovery, transport layer control, and interoperability control. Core 200 is coupled, via a LAN access profile 201, to a LAN interface 202 (e.g., an Ethernet network interface card and associated communications drivers or applications). LAN access point 103n also supports both portions 203a and 203b of the headset profile, one portion 203a emulating the phone 101 in communicating with headset 102 and the other portion 203b emulating the headset 102 in communicating with phone 101. The profile 203b communicating with the phone 101 may alternatively be a cordless phone profile. Selection of the appropriate profile 203a or 203b within a given LAN access point 103a-103n is controlled by core 200.

Referring back to FIG. 1, each LAN access point 103a-103n supports detection of both phone 101 and headset 102, as well as the status of wireless communications between phone 101 and headset 102. For example, assume that headset 102 is initially within range of phone 101, and both are within range of access point 103a. When headset 102 is within range of phone 101, LAN access points 103a-103n are not involved in communications between phone 101 and headset 102. However, when headset 102 is moved out of range of phone 101, and within range of access point 103b, an access point 103a within range of phone 101 and an access point 103b within range of headset 102 replace the wireless connection between phone 101 and headset 102 with emulations of such a connection, with the two access points 103a and 103b coupled over LAN 104. For instance, where LAN 104 is an Internet Protocol (IP) network, a voice-over-IP (VoIP) connection is established between access points 103a and 103b. No elaborate VoIP capabilities are required, so the implementation may be fairly lightweight.

For the present invention to operate as described, phone 101 and headset 102 should both be within range of a LAN access point 103a-103n. LAN access points 103a-103n then need only determine when headset 102 moves out of range of phone 101 but into range with one of LAN access points 103-103n. The emulation of the headset 102 within one LAN access point 103a and of phone 101 within the another LAN access point 103b may then be initiated. An intermediate communications channel between the two access points may also be established.

To allow the user to roam in between calls, but not during calls, LAN access points 103a-103n need not have overlapping or coterminal “coverage” areas. Instead, the areas within the range of adjacent LAN access points may be separated by gaps, with wireless communications to headset enabled on a opportunistic basis, whenever the user (and headset 102) moves within range of an access point 103a-103n (while remaining outside the range of phone 101). In such an implementation, “handoff” between access points is simplified, since each access point 103a, 103b, . . . , 103n need only service the headset 102 while the headset 102 is within range of the respective access point. When the headset 102 moves outside the range of an original access point, service to the headset 102 may be simply terminated until the headset 102 moves within range of another access point (or back into range with the original access point).

Alternatively, the coverage areas of adjacent LAN access points may be overlapping or coterminal, in which case handoff procedures for establishing a point-to-point connection between the access point mated with the phone and the new access point mating with the headset should be supported. More complicated implementations would allow the user to roam within the coverage areas of various access points during a call to keep an existing conversation active, not simply in between calls (i.e., remaining within the coverage area of one access point for the duration of a call).

Even with the simpler implementation limiting user roaming to the intervals between calls, special cases need to be considered, including: making/placing calls; taking/answering calls; and terminating calls. These functions involve call control features normally available only on the phone. However, existing headset designs may be readily modified to incorporate basic call control features, either through physical switches (e.g., buttons), voice tagging/voice recognition, or some combination thereof.

Rather than a local area data network as employed in the exemplary embodiment, the present invention may alternatively be implemented in conjunction with a private branch exchange (PBX) telephone system, where each telephone within the PBX serves as an access point.

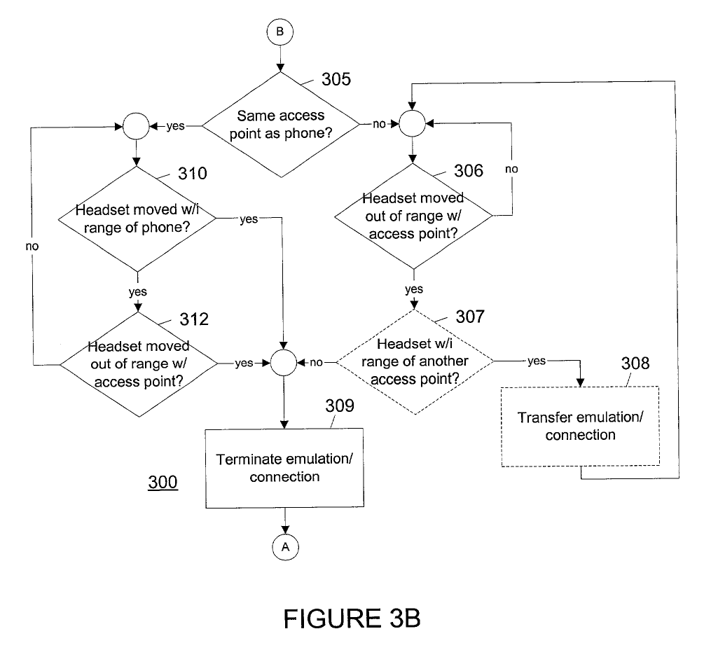

FIGS. 3A and 3B are a high level flow chart for a process of extending the range of a wireless headset beyond the distance supported by an applicable wireless communications protocol according to one embodiment of the present invention. The process 300 is triggered by a phone mated to a wireless headset moving within range of an access point of the type described above (step 301). A determination is then made (step 302) of whether the headset is within range of the phone. If so, the process simply continues to poll the status of the headset with respect to the phone.

If the headset moves out of range with the associated phone, however, a determination is made (step 303) of whether the headset is within range of an access point within a communications system equipped with a plurality of access points for extending the range of wireless headsets with respect to associated phones. The communications system may be a local area IP-protocol data network as described above.

If the headset is not within range of an access point, the process continues polling the status of the headset with respect to the phone and with respect to each of the access points. If the headset is within range of an access point, however, emulation of the phone is initiated within the access point within range of the headset, emulation of the headset is initiated within the access point within range of the phone, and a connection (e.g., VoIP) is established, if necessary, between the access point emulating the phone and the access point emulating the headset (step 304).

Once emulation of the phone-headset mating is initiated, a determination is made (step 305) of whether the phone and the headset are within range of the same access point (although not within range of each other). If not, a determination is made (step 306) of whether the headset has moved out of range with the access point to which the headset is coupled. If not, the process continued polling for movement of the headset out of range with the access point emulating the phone and mated with the headset.

If the headset moves out of range of the access point mated with the headset, an optional determination may be made (step 307) of whether the headset is within range of another access point. Thus, a simple handoff scheme may be implemented wherein the headset remains mated with an access point until it moves out of range of that access point, at which time any access point within range of the headset begins emulating the phone and becomes mated with the headset.

If the headset is within range of another access point, the emulation of the phone and connection with the access point emulating the headset is (optionally) transferred to the new access point (step 308). If the determination of whether the headset has moved within range of another headset is not implemented, or if the headset is not within range of another headset (e.g., the coverage areas of adjacent access points are separated by gaps or the headset moves outside the overall coverage area of the access points taken in aggregate), the emulation of the phone and headset within the respective access points and the connection, if any, between access points is terminated (step 309). The process then returns to polling whether the headset is within range of either the phone or an access point.

Referring back to step 305, if the access point within range of the headset is the same access point within range of the phone (although the phone and headset are not within range of each other), a determination is instead made (step 310) of whether the headset has moved within range of the phone. If so, the emulation of the phone and headset within the access point is terminated. If not, however, a determination is made of whether the headset has moved out of range of the access point (step 312).

If not, the process continues polling for movement of the headset within range of the phone or out of range with the access point. Otherwise the process may proceed to an optional determination, similar to step 307, of whether the headset is within range of another access point. In the example shown, however, the process simply proceeds directly to terminating the emulation of the phone and headset within the access point and polling to determine whether the headset is within range of either the phone or an access point.

The present invention allows a wireless headset to be employed past the distance from an associated phone which is supported by a wireless communications protocol coupling the headset and phone. In addition to solving the problems identified above, the present invention allows a mobile phone to be positioned within a building at a location in which sufficient signal strength exists (e.g., near a window) and left at that location while the user employs a headset to place or receive calls through the phone.

Although the present invention has been described in detail, those skilled in the art will understand that various changes, substitutions and alterations herein may be made without departing from the spirit and scope of the invention it its broadest form.

What is claimed is:

1. For use in a communications system, a system for extending the range of a wireless headset comprising:
a phone;
a wireless headset associated with said phone, said wireless headset capable of communicating directly with said phone utilizing a wireless communications protocol having a distance limit;
a communications system; and
a plurality of access points each coupled to said communications system at one of a plurality of dispersed locations, each access point capable of selectively
emulating said phone utilizing said communications protocol,
emulating said headset utilizing said communications protocol
communicating with said phone within said finite distance from said phone utilizing said communications protocol,
communicating with said headset within said finite distance from said headset utilizing said communications protocol, and
interfacing with said communications system,
wherein said access points are capable of selectively establishing a communications path within said communications system between an access point emulating said phone and an access point emulating said headset, if necessary, to provide communications between said phone and said headset when said phone and said headset are separated by a distance greater than said distance limit.
